(19) United States
(12) Patent Application Publication
(10) Pub. No.: US 2022/0196546 A1
(43) Pub. Date: Jun. 23, 2022

(54) MEASUREMENT DEVICES

(71) Applicant: Hewlett-Packard Development Company, L.P., Spring, TX (US)

(72) Inventor: Philip Wright, Ottawa (CA)

(73) Assignee: Hewlett-Packard Development Company, L.P., Spring, TX (US)

(21) Appl. No.: 17/296,962

(22) PCT Filed: Sep. 11, 2019
(86) PCT No.: PCT/US2019/050565

§ 371 Date: May 25, 2021

(51) Int. Cl. G01N 21/3504; G01C 3/08

(52) U.S. Cl. CPC G01N 21/3504; G01N 2201/0221; G01C 3/08

(57) ABSTRACT

Examples of the present disclosure are directed to a device having a gas sensor. An example device includes a housing having a channel to provide air to a chamber and the chamber located within the housing and coupled to the channel. The example device includes an infrared light to output an infrared beam through the chamber and a gas sensor to measure radiation absorbed at different frequencies of the infrared beam. A processor is coupled to the gas sensor to detect gas molecules present in the air within the chamber based on the measured radiation absorbed.

### BRIEF DESCRIPTION OF FIGURES

Various examples may be more completely understood in consideration of the following detailed description in connection with the accompanying drawings, in which:

FIG. 1A shows an example device having a gas sensor, in accordance with the present disclosure;

FIG. 1B shows a side view of a gas sensor of a device, such as the device illustrated by FIG. 1A, in accordance with the present disclosure;

FIGS. 2A-2B show example chambers, gas sensors, and infrared light sources of a device, in accordance with the present disclosure;

FIGS. 3A-3C show an example chamber, gas sensor, and infrared light source of a device, in accordance with the present disclosure;

FIG. 4 shows example circuits of a device having a gas sensor, in accordance with the present disclosure;

FIGS. 5A-5D show example views of a device having multiple tools including a gas sensor, in accordance with the present disclosure;

FIG. 6 shows an example combustion chamber and sensor of a device, in accordance with the present disclosure;

FIGS. 7A-7C show views of an example voltage sensor of a device, in accordance with the present disclosure;

FIG. 8 shows example circuits of a non-contact voltage sensor of a device, in accordance with the present disclosure; and

FIGS. 9A-9D show an example rangefinder and graphical display of a device, in accordance with the present disclosure;

FIGS. 10A-10B show an example stud finder of a device, in accordance with the present disclosure;

FIGS. 11A-11B show an example of a device having a flow meter, in accordance with the present disclosure; and

FIGS. 12A-12E show example views of a device having multiple tools including a flow meter, in accordance with the present disclosure.

### DETAILED DESCRIPTION

Aspects of the present disclosure are applicable to a variety of different devices and apparatuses involving measurement of gases in the atmosphere. In certain non-limiting examples, aspects of the present disclosure may involve a gas sensor and other measurement tools integrated into a single multi-measurement device. In particular examples, the multi-measurement device may locally determine and store multiple measurements including a determination of gas molecules in the atmospheric air. In some applications, such examples are advantageous in that a single portable and handheld device may be used by a user in the field and which provides multiple different types of measurements that are obtained, processed locally for real-time processing, and/or stored in the cloud.

Certain specific examples involve a portable and handheld device which integrates multiple measurements tools, sometimes herein referred to as a “multi-measurement device”. The device may integrate multiple tools for commercial grade measurements relevant for providing field services. Example field services include home insurance inspectors and other types of inspectors, maintenance staff, home healthcare staff, home improvement workers, such as electricians, plumbers, and other types of construction workers. While in the field, a user may perform a number of different measurements, which are obtained using a plurality of different and separate tools. In various examples, a single device integrates the number of tools into a single housing, with the number of tools being accurate. The device may gather and store the measurements in real time, which may be subsequently and/or periodically communicated to an external circuit via an available communication type, such as cellular, wireless internet, short range communications, and/or a wired internet communication. The device may gather the data and locally determine the measurements using computer executable instructions located locally on the device. As the device may be used in the field, such as in remote locations where access to data signals may be limited, locally measuring and storing the measurements may allow for the user to more easily perform a particular or multiple tasks. The stored measurements may be subsequently downloaded and/or otherwise communicated. For example, the data may be communicated periodically, in response to access to a network and/or in response to a particular measurement.

In a specific example, a device is used to detect gas molecules present in the atmospheric air. In many applications, gas molecules in the air and while the user is on a job may present health concerns for the user. In other applications, the user may detect gas molecules for providing a service. The device has a housing that includes a channel to provide air from the atmosphere to a chamber located within the device. An infrared source outputs an infrared beam through the chamber and a gas sensor measures radiation absorbed at different frequencies of the infrared beam. The gas sensor may include a methane sensor and/or a carbon-dioxide sensor. A processor detects the gas molecules present in the air and within the chamber based on the measured radiation absorbed. In some examples, the device includes a fan to actively draw air into the chamber through an air inlet pathway.

For certain examples involving a multi-measurement device, the device includes a non-contact voltage sensor disposed in the housing. The non-contact voltage sensor includes a movable arm having an antenna and a stationary arm coupled to the movable arm. The movable arm moves from a first position to a second position with respect to the stationary arm. In some examples, the non-contact voltage sensor includes a push-push mechanism to move the movable arm. The stationary arm includes an inverter to convert a voltage, measured using the antenna, to a digital signal. While the movable arm is in the first position, the non-contact voltage sensor is inactive. The non-contact voltage sensor may include a push-activated switch which provides the electrical connection between the antenna and the inverter in response to the movable arm being in the secondary position. The processor of the multi-measurement device processes the digital signal and may output an indication of a voltage present.

In further certain examples involving a multi-measurement device, the device includes a rangefinder that may provide accurate distance measurements that are independent of how level the device is. A rangefinder, which includes a laser source, outputs a laser beam pulse toward an object and measures the laser beam pulse as reflected from the object and returned to the rangefinder. The distance between the object and the device may be determined based on the time of flight of the laser beam pulse. If the device is at an angle of tilt, the time of flight of the laser beam pulse may be different than a direct distance from the device to the object. The multi-measurement device, in specific examples, accounts for the angle of tilt of the device to provide an accurate distance measurement. The device may further include a gyroscope to obtain the angle of tilt of the device while the laser beam pulse is output, a memory to store the angle of tilt, and a processor coupled thereto. The processor may measure a time of flight of the laser beam pulse as returned to the rangefinder, determine a travel distance of the laser beam pulse using the time of flight, and determine a level or direct distance from the device to the object using the travel distance and the angle of tilt.

The above described multi-measurement devices having the gas sensor, the non-contact voltage sensor and/or the rangefinder may include additional tools, such as a combustion analysis tool, the rangefinder with a gyroscope, a stud finder, a digital compass, communication circuits, a digital level, various cameras, noise meters, vibration meters, among other tools and various combinations thereof. For example, the device may include magnets on a top side of the housing which may be used to attract metal components. As another example, the device may include an antenna and multiple radio components that share the antenna using a switch. Other example tools and/or features include a front facing camera, a back facing camera, a thermal camera, a light source which may be used as a flash light, among other features. In certain examples, the multi-measurement device includes various combinations of the above-described tools. For examples, the tools may be modular in that the tools may be selectively coupled to the main printed circuit board of the device, and with different devices including different sub-combinations of tools. As an example, one multi-measurement device may include the above described gas sensor, rangefinder with the gyroscope, and non-contact voltage sensor. Another example multi-measurement device may include the rangefinder with the gyroscope and non-contact voltage sensor, and may not include the gas sensor. Examples are not limited to the above described combinations and sub-combinations, and may include various sets of the described tools and features.

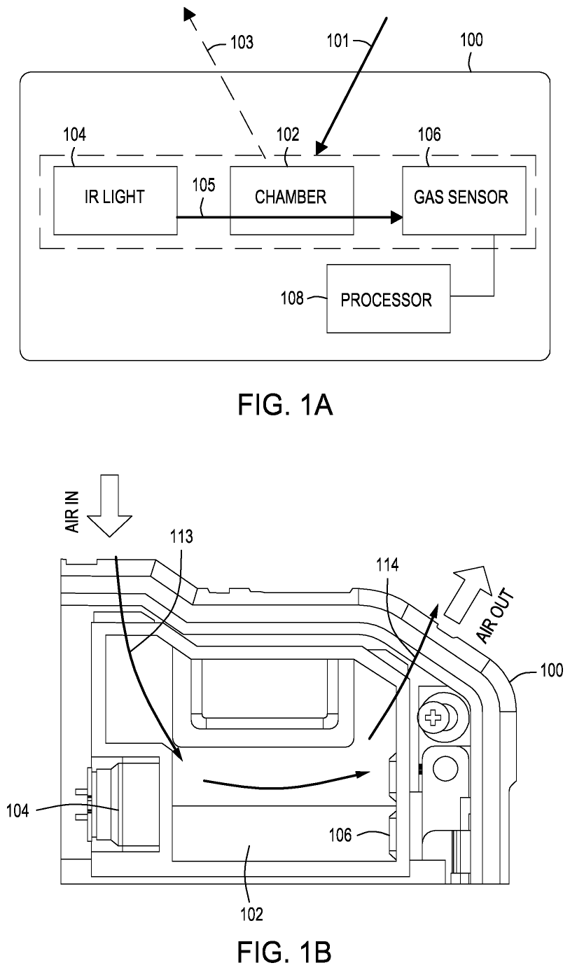

Turning now to the Figures, FIG. 1A shows an example device having a gas sensor, in accordance with the present disclosure. The device may include a gas sensor 106 that tests and/or measures air from the atmosphere for the presence of gas molecules. Example gas molecules include carbon dioxide (CO₂) and methane. The gas molecules present in a particular environment, such as an enclosed room and/or other enclosed locations, may be detected and used to warn users in the location of a health or safety concern.

The device includes a housing 100 having a channel 101 to provide air to a chamber 102. In a number of examples, the housing includes an additional channel 103 to provide air from the chamber 102. The air may be atmospheric air that the device measures for the presence of particular gas molecules. The chamber 102 is coupled to the channel 101 and the air may pass there through. An infrared (IR) light source 104 outputs an IR beam 105 through the chamber 102 and the gas sensor 106 measures radiation absorbed at different frequencies of the IR beam 105. A processor 108 coupled to the gas sensor 106 may detect the gas molecules present in the air within the chamber 102 based on the measured radiation absorbed.

In accordance with various examples, the device has a plurality of channels and a plurality of ports to provide the air to and from the chamber 102. As used herein, a port includes or refers to an aperture formed in the housing 100, which is optionally an aperture formed through the housing and a layer or a plurality of internal layers of the device. In some examples, the ports may be reinforced by an additional channel, such as metal or plastic structural tubes. The ports may provide atmospheric air to and/or from internal components of the device including the channel and a chamber coupled thereto. A channel includes or refers to a pathway to and/or from the chamber, and which directs air toward or from the chamber. In some examples, the channels may include hardware structures, such as pipes or tubes. In other examples, the channels may be formed by gaps or spaces between other components of the device. A respective port of the plurality of ports is coupled to a respective channel to provide atmospheric air to the internal components of the device. For example, the plurality of ports and plurality of channels provide air inlet and air outlet pathways to and from the chamber 102. As further illustrated herein, a port and/or the plurality of ports may include a mesh to mitigate and/or prevent liquid from entering the respective channel and may be located on particular sides of the housing 100.

The gas sensor 106 may include a plurality of gas sensors, such as a methane sensor and a CO₂ sensor. In such examples, the IR light source 104 may include a plurality of IR light sources, with each outputting an IR beam through the chamber 102 and toward the respective gas sensor of the plurality of gas sensors. The gas sensors may include use of IR spectroscopy to identify gas molecules present in the chamber based on the IR beam directed through the chamber 102 and at the respective gas sensor, and which measure the radiation absorbed at a different frequency. The processor 108 may use the output radiation absorbed to determine a concentration and/or type of gas molecule present in the air.

The air may be provided to the chamber 102 via the channel 101 using active and/or passive airflow. Passive airflow may occur through natural movement of air. More specifically, with passive airflow, the air may be provided to the chamber 102 and from the chamber 102 without an active response by the device. With active airflow, air is actively drawn into the chamber 102 by a component of the device, such as a fan. For example, a fan may be coupled to the channel 101 and the chamber 102 to draw air into the chamber 102. The active airflow may allow for a faster measurement than passive airflow. In a number of specific examples, the device may employ a dual mode operation that uses both active and passive airflows.

As further described and illustrated herein, various measurement tools may be integrated within the housing 100 in addition to the gas sensor 106. For example, the device has the housing 100 in which multiple tools are integrated within and is of a size that is portable. Example tools include a rangefinder, a gyroscope or a plurality of gyroscopes, a digital compass, a digital level, a stud finder, a non-contact voltage sensor, a combustion chamber and sensor, such as a volatile organic compounds (VOC) sensor, and an air flow meter, among other tools and various combinations of the example tools. Other additional tools and/or features of the device may include communication circuits, a thermal imaging camera, a ruler with protractor, ultra-violet (UV) light, such as a 364 nanometer UV light, a flashlight, a proximity sensor, an ambient light meter, back side and front side cameras, a noise meter, and/or a vibration meter. The device may have various input/output connectors, such as a universal serial bus (USB) connector.

The multi-measurement device may locally gather and store a variety of measurements. The multi-measurement device may process the measurements, using computer executable instructions locally stored, to determine additional information, such as processing for predictive analysis, vibration prediction, and diagnostics, among other analyses. The user may additionally enter data into the device by a touch display. The measurements and/or additional information processed onboard the multi-measurement device may be communicated to an external circuit for further analysis and improvement of the executable instructions on the device.

FIG. 1B shows a side view of a gas sensor of a device, such as the device illustrated by FIG. 1A, in accordance with the present disclosure. More specifically, FIG. 1B illustrates an example chamber 102 within a housing 100 and as coupled to a channel and port. The channel is coupled to the port and provides an input airflow pathway 113. The device may include another channel coupled to another port that provides an output airflow pathway 114. The gas sensor 106 and a portion of the IR light source 104 are coupled to the channel. As shown by FIG. 1B, the chamber 102 and channels may overlap. In some examples, the channels may be formed of gaps within the housing 100. The gaps may be formed by the locations of other components of the device, and which provide space for air to flow. In other examples, although not illustrated by FIG. 1B, the channels may be separate hardware structures, such as tubes formed of a material.

In a number of examples, the airflow pathway may include passive airflow. For a passive airflow, the device may include a first channel and a first port that provide an input airflow pathway 113 to the chamber 102 and a second channel and a second port that provide an output airflow pathway 114 from the chamber 102. Although examples are not so limited and devices may include additional and/or fewer channels and ports than illustrated by Figures IA and 1B and/or the airflow may be passive and/or active airflow. As an example, the device may include both active airflow and passive airflow, and which may be used concurrently and/or separately.

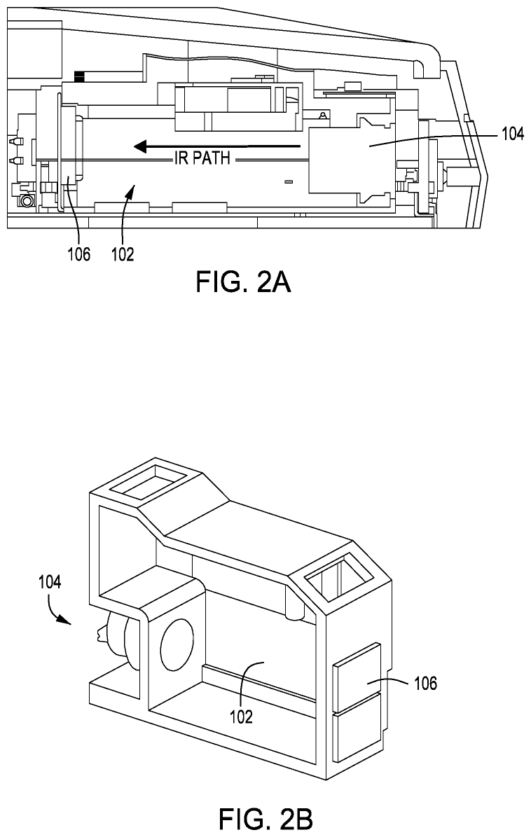

FIGS. 2A-2B show an example chamber, gas sensor, and IR light source of a device, in accordance with the present disclosure. More specifically, FIG. 2A shows a side view and FIG. 2B shows an angled side view of the chamber 102, gas sensor 106 and IR light source 104 as previously described in connection with FIGS. 1A-1B. The gas sensor 106 may include a plurality of gas sensors used to detect gas molecules from the IR beam output by the IR light source 104 through the chamber and toward the gas sensor 106.

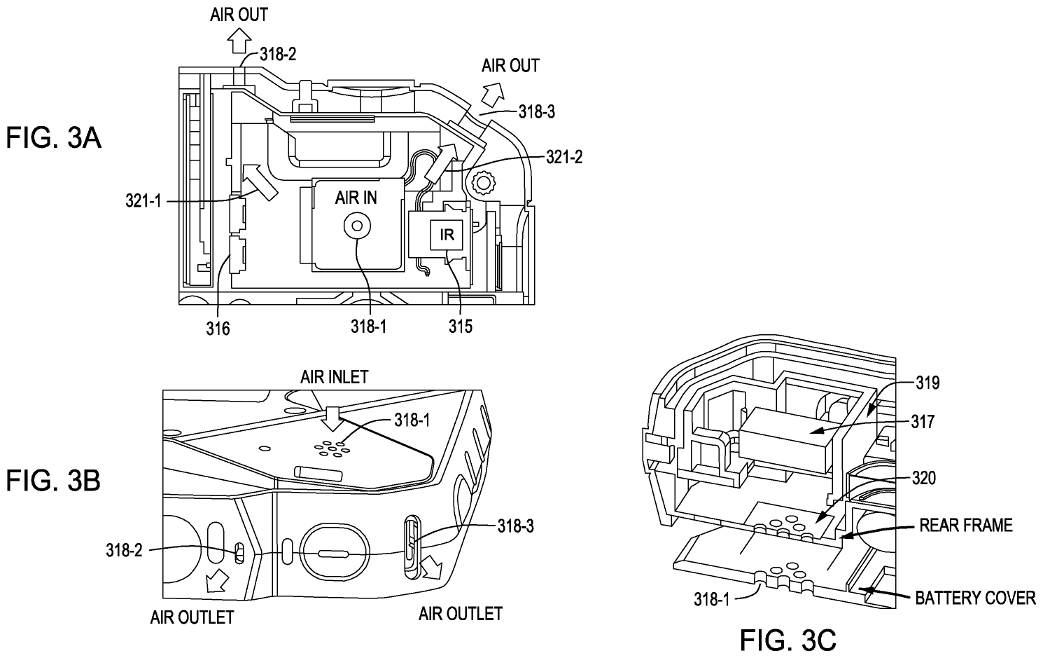

FIGS. 3A-3C show an example chamber, gas sensor, and IR light source of a device, in accordance with the present disclosure. The device may include a chamber 319 within a housing. The chamber 319 is coupled to a plurality of channels 321-1, 321-2 and ports 318-1, 318-2, 318-3 that provide input airflow and output airflow pathways to and from the chamber 319. In various examples, the device includes multiple output airflow pathways. As shown by FIGS. 3A and 3C, a fan 317 may be located proximal to the plurality of channels 321-1, 321-2, the plurality of ports 318-1, 318-2, 318-3 and the chamber 319 to actively draw air into the chamber 319 through the input airflow pathway. An IR light source 315 outputs an IR beam through the chamber 319 to detect gas molecules in the air via the gas sensor 316, as previously described. Although the active and passive airflow mechanisms are illustrated separately by FIGS. 1B and 3A-3C, a number of devices may use both the active and passive airflow mechanisms.

The ports 318-1, 318-2, 318-3 may be located at a back side and a top side of the housing, as illustrated by FIG. 3B. More specifically, a first port 318-1 is located at the back side of the housing and is coupled to a first channel that provides air to the chamber 319. In a specific example, the first port 318-1 on the back side of the housing includes a plurality of apertures formed in the housing. Second and third ports 318-2, 318-3 are located on the top side of the housing and may be coupled to the second and third channels 321-1, 321-2 that provide air from the chamber 319, with the air exiting the device via the second and third ports 318-2, 318-3. In a number of specific examples, as illustrated by FIG. 3C, a mesh 320 is located between the first port 318-1 and additional internal components of the device. The mesh 320 may mitigate or prevent liquid from entering the device. Although the mesh 320 is illustrated as being proximal to the first port 318-1, examples may include mesh additional located proximal to the second and/or third ports 318-2, 318-3, such as proximal to the plurality of ports 318-1, 318-2, 318-3. Additionally and/or alternatively, the ports of a device that implements active airflow may include a mesh proximal thereto.

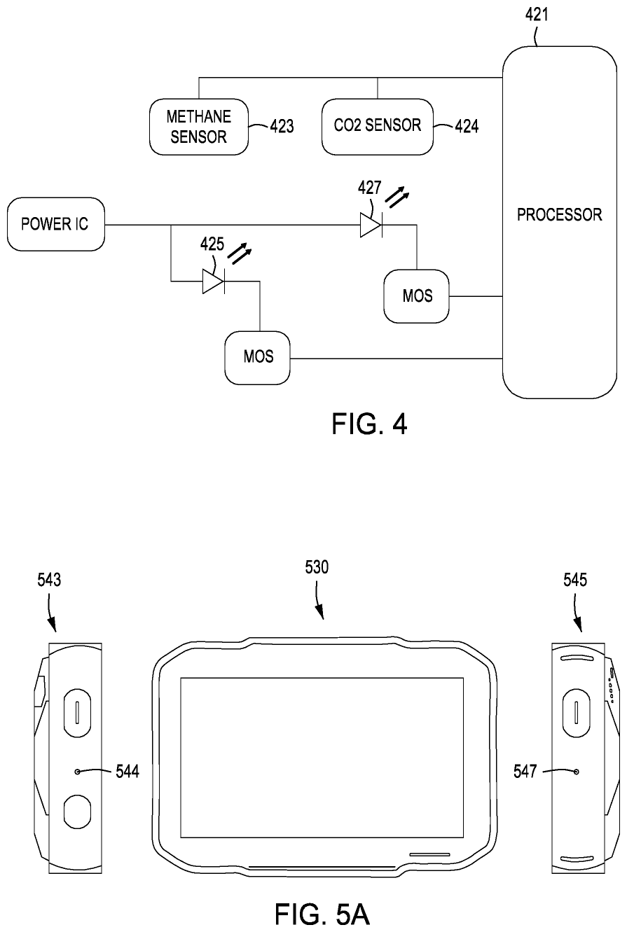

FIG. 4 shows example circuits of a device having a gas sensor, in accordance with the present disclosure. The gas sensor may include a methane sensor 423 and a CO₂ sensor 424 coupled to a procssor 421 of the device. A power source, such as a power integrated circuit (IC), powers first and second IR light sources 425, 427 which provide a first IR light beam and a second IR light beam through a chamber and respectively toward the methane sensor 423 and the CO₂ sensor 424. The methane sensor 423 and the CO₂ sensor 424 measure the radiation absorbed at different frequencies and output the radiation absorbed to the processor 421 of the device to determine a concentration and/or type of gas molecule present. The first and second IR light sources 425, 427 may be coupled to the processor 421 via transistors, such as the illustrated first and second metal-oxide-silicon transistor (MOS).

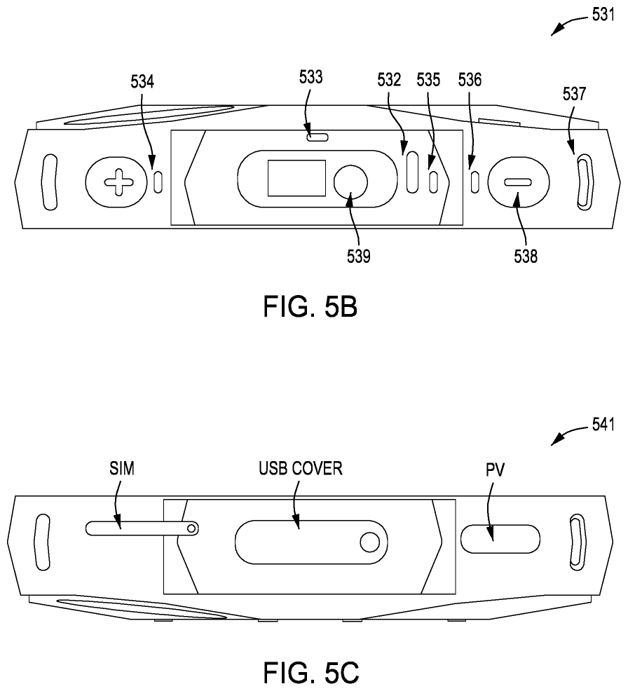

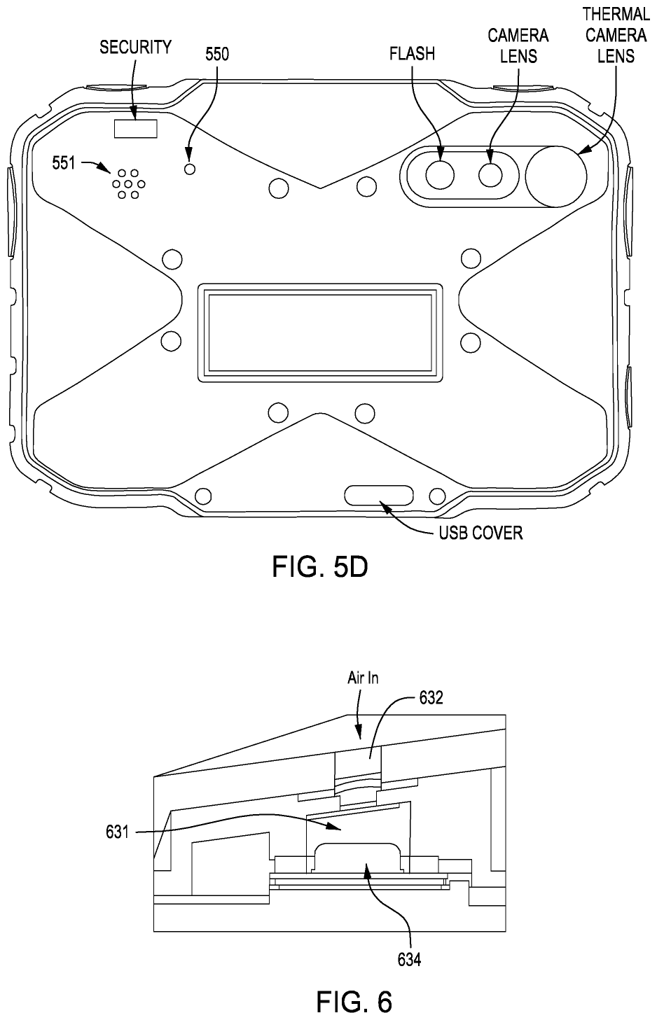

FIGS. 5A-5D show example views of a device having multiple tools including a gas sensor, in accordance with the present disclosure. The device has a housing with a front side 530, a back side 549, a top side 531, a bottom side 541 and two peripheral sides 543, 545. A number of examples are directed to a multi-measurement device that is used to obtain and store a variety of different measurements. The multi-measurement device may be of a size that is portable and may be carried by the user. For example, the device is sized to be held by one hand of a user. As a specific example, the device may have dimensions in the millimeter (mm) range. As a more specific example and non-limiting, the device is approximately 50-100 mm in length and width, such as 900 mm in length and 66 mm in width, and has a 3.5 inch touch display on the front side. Altough examples are not so limited and the device may be a variety of different sizes and have different sized displays, such four inch to six inch displays.

FIG. 5A shows an example view of the front side 530 and two peripheral sides 543, 545 of the device. The front side 530 includes a display that provides a graphical user interface. A variety of different information may be displayed on the display and may allow the user to provide inputs to the device. The front side 530 further includes various indicators, such as lights, a speaker which optionally has a mesh as previously described with respect to the ports, a proximity sensor, and/or a front-facing or front side camera. The first peripheral side 543 includes a trigger key, a first microphone aperture 544 and/or an auxiliary key. The second peripheral side 545 includes a second microphone aperture 547 and an optional lanyard aperture for connecting a lanyard to the device.

In certain examples, the multi-measurement device locally gathers and stores a variety of measurements, which may be determined by the device in real-time and/or without communicating to external sources. The multi-measurement device locally processes the measurements, using a processor and executable instructions locally stored on memory, and to determine the measurements and/or additional information. For example, a field service worker may use the single multi-measurement device to perform a set of measurements. In various examples, the executable instructions may be used to process the measurements and to increase an accuracy of the resulting data. In some examples, the gathered measurements may be communicated to an external source. The device may locally gather and process data, and communicates the processed data when the device is connected to a network. The measurements and additional information processed onboard the multi-measurement device may be communicated to an external circuit, such via the cloud, for further analysis and/or improvement of the executable instructions on the device.

The executable instructions locally stored on the device may be updated over time and based on further improvements in analysis. For example, a plurality of multi-measurement devices may communicate data to external circuitry and the external circuitry uses the various data to update the executable instructions for subsequent measurements and to increase an accuracy of measurements obtained by the devices. As the communicated data is not the full live stream of data, this may reduce the amount of data communicated and the bandwidth to communicate the data. The updates to the executable instructions are communicated to the devices for storage.

In some examples, the devices illustrated by FIGS. 5A-5D may be used to measure an airflow rate and/or air flow direction using the microphones on the first peripheral side 543 and the second peripheral side 545. More specifically, the device may include a digital compass and the two integrated microphones which are coupled to the first microphone aperture 544 and the second microphone aperture 547 and are used to measure an air flow direction and/or velocity. The device may be calibrated to the environment prior to the measurement. The calibration may be used to filter noise, such as in the 25 decibel B range and filter between 20 hertz (Hz) to 200 Hz. As a specific example, the digital compass and two integrated microphones may be used to measure a velocity, such as cubic feet per minute.

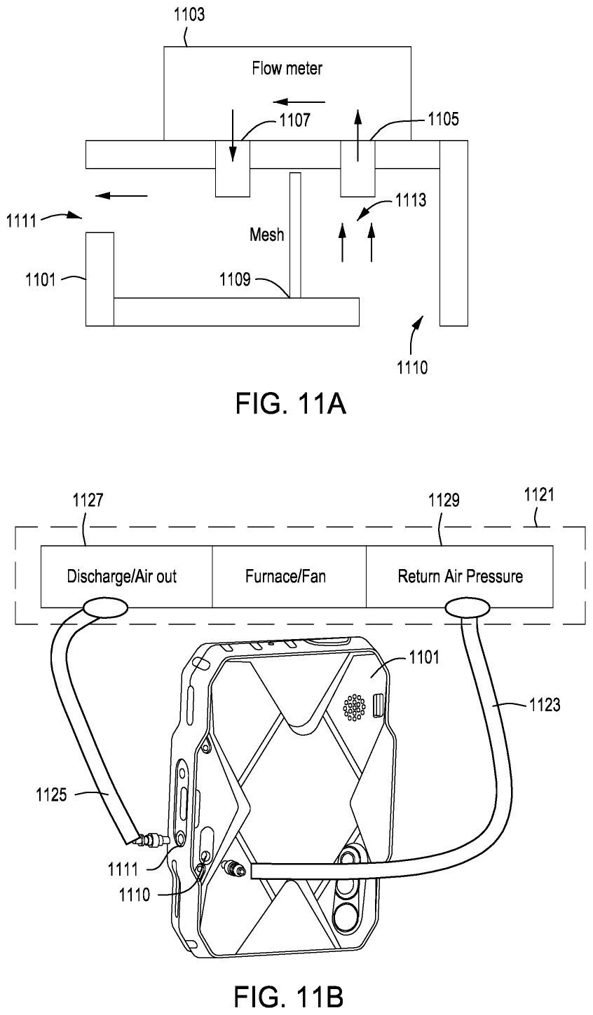

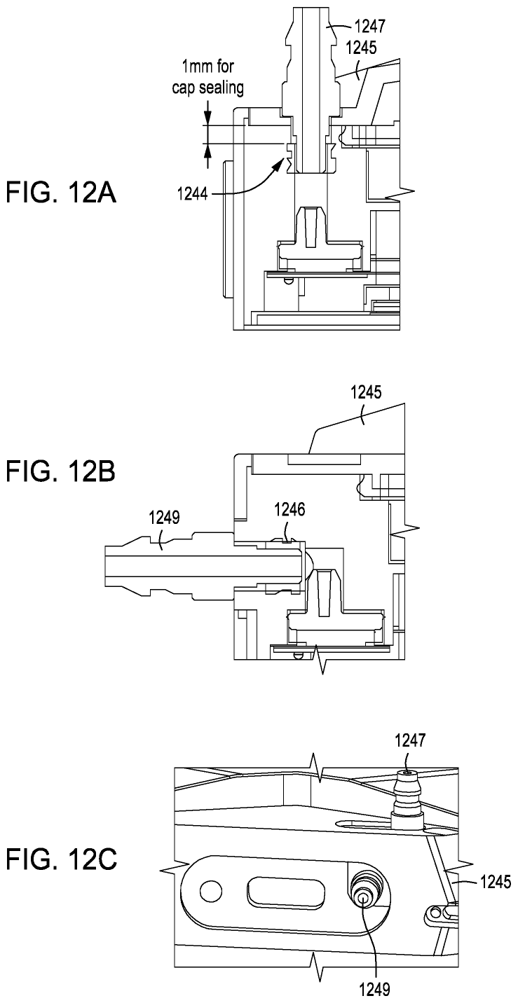

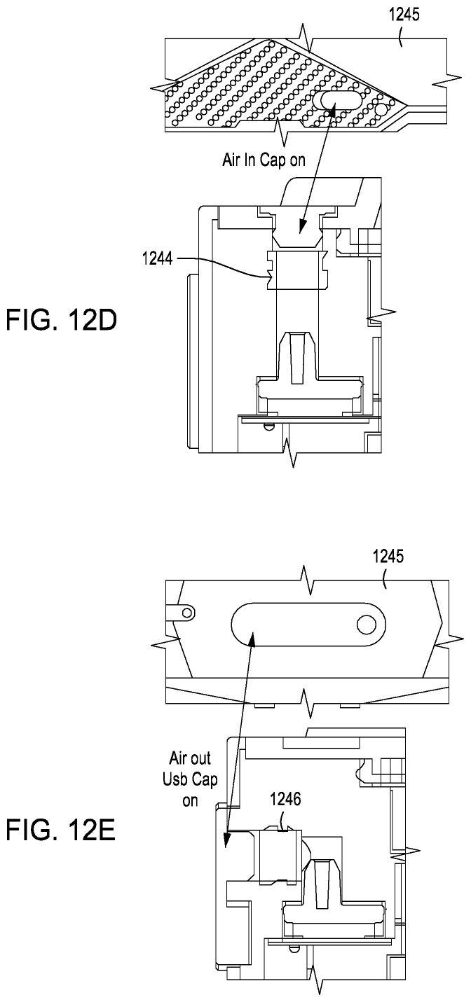

FIGS. 5B and 5C show the top side 531 and bottom side 541 of the device. The top side 531 may include light emitting diodes (LEDs) 533, 534, 536 such as an indicator LED 533, a fire LED 534, and/or a UV LED 536. The top side 531 may optionally include a push-push mechanism 532 for accessing a non-contact voltage sensor, as further described herein. In various specific examples, as described above, the plurality of ports used to provide air to and from the chamber may be located at the top side 531 and/or back side 549 of the housing. For example, the ports 535 and 537 may include air inlet and/or air outlet ports for the gas sensor described by FIG. 1A and FIG. 1B. The top side 531 further includes a lens of a rangefinder 539 and/or a volume input key 538. The bottom side 541 may be flat or substantially flat, as further shown by the back side 549. The bottom side 541 includes a sim card door, a USB cover for a USB input, and/or a power button. In specific examples, the USB cover may cover another output port (or input port) for a flow meter, as further illustrated by FIGS. 11A-11B and 12A-12E.

FIG. 5D shows an example of the back side 549 of the device. The back side 549 includes the input port 551 coupled to the fan, a security aperture, an input port 550 coupled to the combustion chamber (which may optionally include the input port 551 coupled to the fan), a flash, a back-facing or back side camera lens, and/or a thermal camera lens. The back side 549 may additionally include a USB cover that covers another input port (or output port) for the flow meter.

Certain examples are not limited to a multi-measurement device having a gas sensor. For example, various devices may include other tools and without a gas sensor, as further described herein.

FIG. 6 shows an example of example combustion chamber and sensor of a device, in accordance with the present disclosure. In such an example, the device includes the combustion chamber 631 and an additional air inlet port 632 that is coupled to another channel to provide material to the combustion chamber 631. Further coupled to the combustion chamber 631 is an additional sensor 634, such as a VOC sensor, and a heat source to heat material in the combustion chamber 631 and to detect different organic compounds and/or an air quality index. A VOC sensor may use an ultraviolet (UV) light source to knock electrons out of the VOC molecules and which are measured. As the material in the air is heated up, the temperature changes and which creates different profiles used to detect gases and other material based on the profiles. In some examples, the combustion chamber 631 includes or is located proximal to, such as beneath or within, the fan of the gas sensor, as described in connection with FIGS. 3A-3C. In other examples, the previously described chamber of the gas sensor and the combustion chamber are one integrated chamber. Other types of sensors may additionally and/or alternatively be used to provide measurements using the combustion chamber 631. Such measurements may include temperature, humidity, pressure and/or altitude obtained using various types of sensor, such as an environmental sensor that integrates multiple measurements, a pressure sensor, moisture sensor, gyroscope, vibration sensor, among others. For example, a single environmental sensor may measure temperature, humidity, pressure, altitude, and VOCs, among other measurements.

A device having the gas sensor and/or combustion analysis may be used to detect for gas molecules, concentrations, and other materials in the air, and which may be a health hazard to users present in the area. In response to the detection, such as a concentration of gas molecules that is above a threshold, the device may provide an indication to the user. Example indications include a warning message on the display, a light and/or sound to alert the user. Additionally and/or alternatively, a message may be communicated from the device to an external circuit, such as to a supervisor. The measurement and communicated message may be used to improve working conditions and/or provide safety for users.

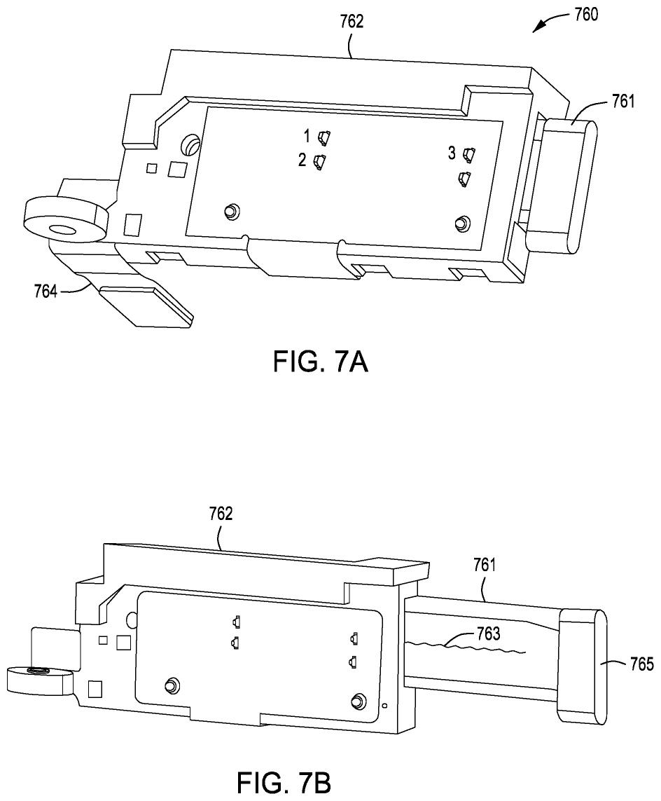

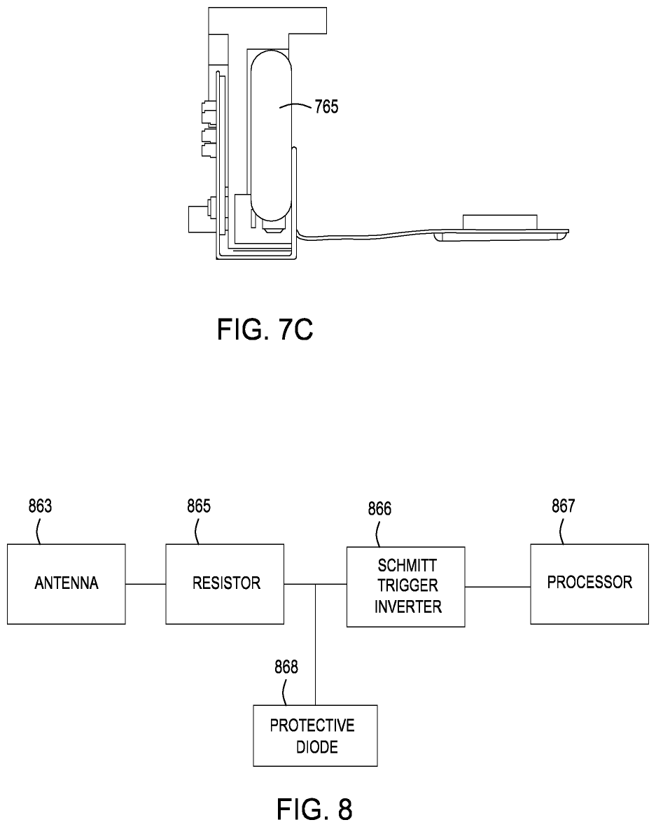

FIGS. 7A-7C show an example voltage sensor of a device, in accordance with the present disclosure. The voltage sensor may be integrated into a multi-measurement device having the gas sensor, such as the device illustrated by FIGS. 1A-1B. Although examples are not so limited and examples include a device having the integrated voltage sensor without a gas sensor.

The voltage sensor is a non-contact voltage sensor 760 that is disposed in a housing of a device, such as the housing illustrated by FIGS. 1A-1B and/or FIGS. 5A-5D. As shown by the side view of the non-contact voltage sensor 760 illustrated by FIGS. 7A-7C, the non-contact voltage sensor 760 includes a movable arm 761 having an antenna 763 located therein. The antenna 763 is used to measure a voltage when the non-contact voltage sensor 760 is activated, such as an induced analog voltage.

The non-contact voltage sensor 760 may be activated through a push-push mechanism and a switch. For example, the movable arm 761 is coupled to a stationary arm 762 having an inverter to convert a measured voltage, as measured by the antenna 763, to a digital signal. As shown by FIG. 7A, the stationary arm 762 may include a connector 764 to connect to the device. For example, the connector 764 may connect to a printed circuit board of the device and to couple to the processor of the device. The movable arm 761 moves from a first position, as illustrated by FIG. 7A, to a second position with respect to the stationary arm 762, as illustrated by FIG. 7B. The non-contact voltage sensor 760 further includes a switch, such as an electrical switch that is push-activated by a push-push mechanism. The push-activated switch may provide an electrical connection between the antenna 763 of the movable arm 761 and the inverter of the stationary arm 762 in response to the movable arm 761 being in the second position. In response to the electrical connection, the non-contact voltage sensor 760 is activated and the inverter may convert an induced analog voltage to the digital signal. The digital signal is input to the processor of the device, such as input for a general purpose input output (GPIO) at the processor. The processor is coupled to the non-contact voltage sensor 760, and in the housing of the device, and processes the digital signal and outputs an indication of the measured voltage.

As described above, the non-contact voltage sensor 760 may include a push-push mechanism to move the movable arm 761 from the first position to the second position and from the second position to the first position. For example, in response to a push input to the front portion 765 of the movable arm 761, the movable arm 761 moves to the second position as illustrated by FIG. 7B. The push input includes and/or refers to a physical push action by the user and which is input to the front portion 765 of the movable arm 761. The non-contact voltage sensor 760, in response the movable arm 761 being in the second position, is automatically activated and/or turned on, and may start measuring for a voltage present. In response to measuring a voltage, an alert may be provided to the user. The non-contact voltage sensor 760, in specific examples, may be a 1000 volt sensor that detects voltage using a schmitt trigger inverter.

The non-contact voltage sensor 760 may have width, height, length and depth dimensions in the mm range. As specific examples, the movable arm 761 may eject a distance of approximately 5-10 mm, such as 6 mm. The total length of the non-contact voltage sensor 760 may be approximately 15-30 mm, such as 22 mm, with a height of approximately 5-10 mm, such as 9 mm, and a width of approximately 5 mm, although examples are not so limited. The stationary arm 762 may have a number of pins, such as the illustrated pins that are numbered 1, 2, 3, and 4. The pins may be used for detecting voltage and for electrical contact, such as pins 1 and 2 for detecting voltage and pins 3 and 4 for electrical contact. In various examples, the non-contact voltage sensor may be located on a top side of the device such that the front portion 765 of the movable arm 761 is accessible to a user. An example top side of a device is illustrated by FIG. 5B. However, examples are not so limited and the non-contact voltage sensor 760 may be located on one of the perimeter sides of the device.

FIG. 8 shows example circuits of a non-contact voltage sensor, in accordance with the present disclosure. As shown, the non-contact voltage sensor includes an antenna 863 which is electrically connected to a schmitt trigger inverter 866 via a resistor 865 and a protective diode 868. Various types of switches may be used including mechanical switches, such as throw switches, and electrical switches, such as transistors. The antenna 863 may be electrically connected via the push-push mechanism and the switch. The schmitt trigger inverter 866 converts the measured voltage to a digital signal which is provided to the processor 867. The processor 867 processes the digital signal and outputs an indication of the measured voltage. The output may include a graphical display on a graphical user interface of the device having the non-contact voltage sensor. The display, for example, may provide a warning to the user. In other examples and/or in addition, the output may include a light and/or a sound to alert the user of the measured voltage.

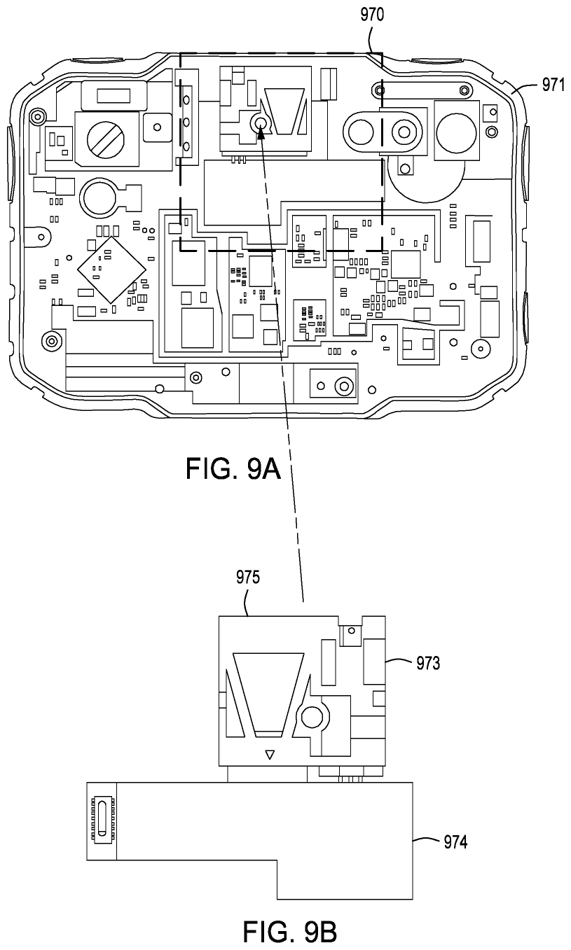

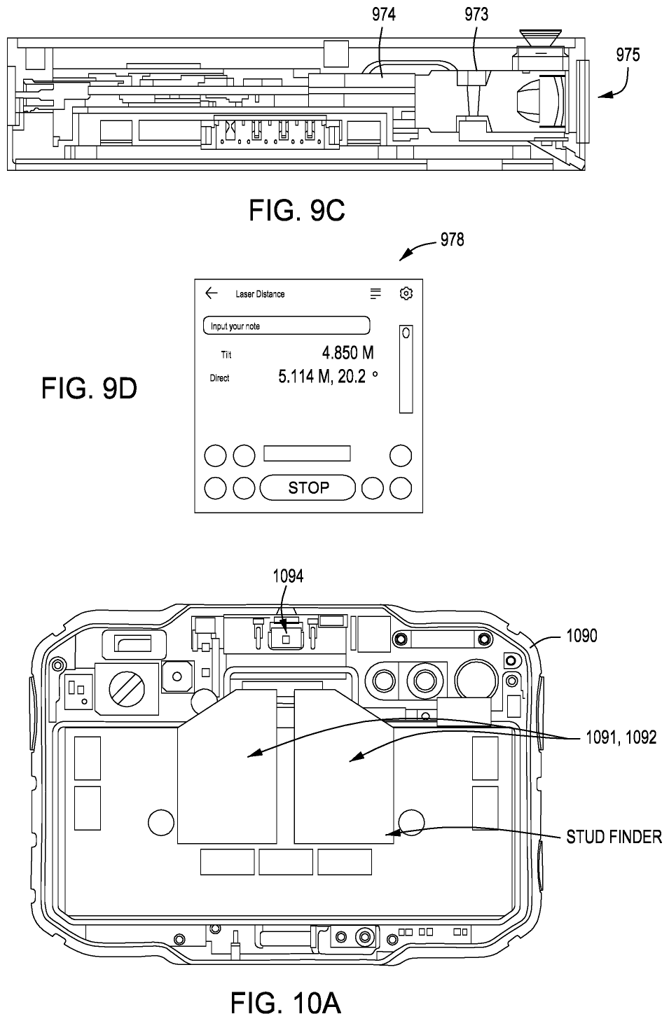

FIGS. 9A-9D show an example rangefinder and graphical display of a device, in accordance with the present disclosure. The rangefinder may be integrated into the device having the gas sensor and/or the non-contact voltage sensor, such as the device illustrated by FIGS. 1A-1B and the voltage sensor illustrated by FIGS. 7A-8. Although examples are not so limited and examples include a device having the rangefinder without a gas sensor and/or without the non-contact voltage sensor. For example, FIG. 9A illustrates an example location 970 of a rangefinder in a housing 971 of a device, such as the device illustrated by FIGS. 5A-5D.

A user may use the rangefinder to determine various distances for a variety of purposes, such as material estimations and volume estimations. As a specific example, a height and width of a wall may be measured to determine an amount of paint product to purchase and/or to use in a bidding process. As another example, a length, width, and depth of a room may be measured to determine the volume of the room, such as for heating, ventilation, and air-conditioning (HVAC) applications. The measurements may be obtained and stored locally on the device. In a number of instances, the user may be unable to obtain a measurement using the rangefinder while the device is level. For example, there may be obstructions and/or objects in the measurement path and/or the user may accidentally hold the device at an angle of tilt. As the device is at an angle of tilt while a measurement is obtained, the distance calculated using the measurements may be different than the distance intended to be measured. As further described below, the device may accurately obtain distance measurements using a rangefinder when the device is at an angle of tilt.

As shown by the various views illustrated by FIGS. 9A-9D, the device includes a rangefinder 973 and a gyroscope 974. The rangefinder 973 includes a laser source to output a laser beam pulse toward an object and measure the laser beam pulse as reflected from the object and returned to the rangefinder 973. The rangefinder 973 may further include a lens 975 coupled to the laser source. The gyroscope 974is used to obtain an angle of tilt of the device while the laser beam pulse is output. More specifically, the gyroscope 974 may determine whether or not the device is level while the measurement is taken by the rangefinder 973. FIG. 9C illustrates a side view of the rangefinder 973 and the gyroscope 974. FIG. 9D illustrates a view of the rangefinder 973 and the gyroscope 974.

The device further includes a memory to store executable instructions and a processor coupled to the memory, the rangefinder 973 and the gyroscope 974. The processor, responsive to execution of the instructions, measures a time of flight of the laser beam pulse as returned to the rangefinder, determines a travel distance of the laser beam pulse using the time of flight, and determines a (level) distance from the device to the object using the travel distance and the angle of tilt. The travel distance may include a different distance than the actual physical distance to the object due to the tilt of the device. For example, the determined distance includes a level or direct distance between the rangefinder and the object without the angle of tilt of the device. The processor may locally store the distance in the memory.

In some examples, the user is guided to obtain more accurate measurements, such as a display that illustrates a visual level and that indicates the device is at an angle of tilt. In addition and/or alternatively, the travel distance is adjusted using the angle of tilt to provide a distance from the rangefinder to the object without the angle of tilt, as described above. For example, the rangefinder 973 and the gyroscope 974 may be used to obtain a distance that is within ⅛ of an inch of the actual distance, when the device is level and when the device is at an angle of tilt. In a specific example, the following instructions may be executed by the processor to adjust the travel distance using the angle of tilt and the calculation of: distance level=travel distance x cos(angle of tilt).

FIG. 9D shows a specific example of a graphical user interface that may be displayed on the display of the device. As shown, the graphical user interface 978 may include a visualization of a level that illustrates the angle of tilt, similar to a physical level and based on the angle of tilt from the gyroscope. The graphical user interface 978 may additionally include a display of the numerical value of the tilt and the travel distance with the angle of tilt and/or direct distance without the angle of tilt.

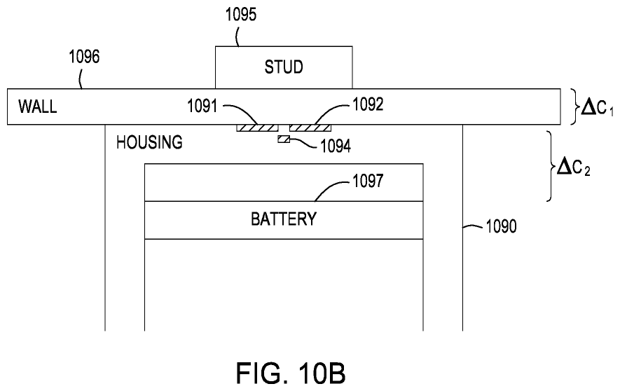

FIG. 10A shows an example stud finder of a device, in accordance with the present disclosure. The stud finder may be integrated into a multi-measurement device having the gas sensor, the non-contact voltage sensor, and/or the rangefinder such as the device illustrated by FIGS. 1A-1B, the voltage sensor illustrated by FIGS. 7A-8, and the rangefinder illustrated by FIGS. 9A-9D. Although examples are not so limited and examples include a device having the integrated stud finder without a gas sensor, without the non-contact voltage sensor and/or without the rangefinder.

The stud finder may include a capacitive sensor that is coupled to a first capacitive plate 1091 and a second capacitive plate 1092 which are disposed on a surface of the housing 1090 of the device. A processor of the device may detect a stud based on changes in capacitance between the first capacitive plate 1091 and the second capacitive plate 1092 as measured by the capacitive sensor, which may be located behind the first and second capacitive plates 1091, 1092. The capacitive plates 1091, 1092 coupled to the capacitive sensor may form capacitive sensing pads. In specific examples, a minimum distance between the capacitive plates 1091, 1092 and the ground plane of the device may be 5 mm, as further described herein.

Using the two capacitive plates 1091, 1092, as compared to one plate, may increase an accuracy of center and edge detection of the stud behind a wall by comparing the capacitance magnitude from one of the capacitive plates 1091, 1092 to the other. When a first capacitance level associated with one of the capacitive plates 1091, 1092 that previously increased, starts to decrease, and the second capacitance level associated with the other of the capacitive plates 1091, 1092 equals that of the first capacitance level, the center of the stud is located. In some specific examples, a light may be activated, such as an LED light that projects onto the wall to notify the user of the center of stud. The capacitive plates 1091, 1092 may have height and width dimensions in the mm range.

The device may further include a digital compass 1094 disposed in the housing 1090 that provides a directional signal. The digital compass 1094 may include a plurality of magnetic field sensors coupled to the processor of the device and/or a microprocessor of the digital compass which is coupled to the processor of the device. The digital compass 1094 outputs directional signals, which are digital signals that are proportional to its orientation and which may occur at a rate which is dependent on a type of material. The digital compass 1094 may respond differently to different types of material. As an example, the digital compass 1094 may be used to distinguish between wood material and metal material, as detected by the stud finder, by the speed and/or strength of the directional signal from the digital compass 1094. This pattern may be learned and/or calibrated, for example, by an external circuit and downloaded to the device. A warning message may be provided in response to detecting metal material, in some specific examples.

FIG. 10B shows an example of using the device to detect a stud 1095 using the capacitive plates 1091, 1092 on the surface of the housing 1090 and the digital compass 1094. For capacitive sensing, an area (A) of the capacitive plate is considered for calculating the capacitance, with A being equal to the length times the width of one of the capacitive plates 1091, 1092. The capacitance of the two planes which include one of the capacitance plates, such as the first capacitive plate 1091, and the stud 1095, includes:

$$C [ pF ] = \frac{0.0886 \times w \times l \times {ɛ}_{r}}{h} ,$$

wherein h is the distance that separates the planes, w is the width of the capacitance plate, l is the length of the capacitive plate and eᵣ is the dielectric constant of the material of the wall 1096. When in use, the capacitance plates 1091, 1092 and stud 1095, which may be formed of wood, are separated by a wall 1096, which may be formed of gypsum board and which is a dielectric. If AC₁ is greater than AC₂, the capacitive sensor may detect wood behind the wall 1096, due to the field radiated from the capacitance plates 1091, 1092 toward the wall 1096. As illustrated, AC1 is from the side of the wall 1096 proximal to the stud 1095 to the surface of the capacitance plates 1091, 1092 proximal to the opposite side of the wall 1096 and AC2 is from the opposite surface of the capacitance plates 1091, 1092 to the device ground plane, such as the battery 1097. In some specific examples, to detect the stud 1095 for a wall that is made of 15 mm thick gypsum board, the distance between the capacitance plates 1091, 1092 to the battery 1097 may be a minimum of 5 mm such that AC1 is greater than AC2.

FIGS. 11A-11B show an example device having a flow meter, in accordance with the present disclosure. The device may include a flow meter that tests and/or measures pressure and/or airflow of a coupled external system. An example coupled system includes an HVAC system 1121. The flow meter 1103 is located internal to the device and may be used to measure airflow, gauge pressure, and differential pressure of the HVAC system 1121. The device may include a multi-measurement device having a plurality of different tools integrated therein, as previously described.

The device includes a housing 1101 having a chamber 1113 located within and coupled to ports 1110, 1111 of the device. The ports 1110, 1111 may include an input port 1110 and an output port 1111. The chamber 1113 is further coupled to a flow meter input port 1105 and flow meter output port 1107. Air enters the device via the input port 1110 and flows to the chamber 1113 and into the flow meter 1103 via the flow meter input port 1105. The air flows through the flow meter 1103 back into the chamber 1113 via the flow meter output port 1107 and out of the device via the output port 1111. The chamber 1113 may include a mesh 1109 that divides the chamber 1113 into two parts and which may mitigate and/or prevent liquid from entering the device.

In a number of examples, as illustrated by FIG. 11B, the input port 1110 and the output port 1111 are coupled to input and output channels, such as the illustrated input hose 1123 and output hose 1125. The channels may be flexible, in specific examples. The flow meter 1103 is used to measure pressure and airflow of a system coupled to the input hose 1123 and output house 1125. In the specific examples, barbs may be attached to the input and output ports 1110, 1111 that couple to first ends of the input and output hoses 1123, 1125. The second ends of the input and output hoses 1123, 1125 are coupled to the external system. In the specific example of FIG. 11B, one of the input port 1123 and output port 1125 is coupled to the discharge/air out connection point 1127 of the HVAC system 1121 and the other of the input port 1123 and output port 1125 is coupled to the return air pressure connection point 1129 of the HVAC system 1121. For example, the input port 1110 is coupled to the return air pressure connection point 1129 of the HVAC system 1121 and the output port 1111 is coupled to the discharge/air out connection point 1127 of the HVAC system 1121. In various examples, a processor of the device is coupled to the flow meter 1103 and may detect airflow, gauge pressure and/or differential static pressure of the HVAC system 1121. Although examples are not limited to flexible hoses and may include other channels, such as tubings and/or rigid hoses.

FIGS. 12A-12E show example views of a device having multiple tools including a flow meter, in accordance with the present disclosure. The device may include the flow meter 1103 including the flow meter input and output ports 1105, 1107, the chamber 1113, the input and output ports 1110, 1111, as described in connection with FIGS. 11A-11B. The input and output ports of the device, which are coupled to the chamber, may be designed to attach to barbs 1247, 1249 that couple to first ends of hoses. The hoses may be attached to an external system, such as an HVAC system, at second ends of the hoses. A cap may be placed over the input and output ports by coupling to the housing 1245 and the ports when the flow meter in not in use.

More specifically, FIGS. 12A-12C illustrate views of the input and output ports of a device with barbs 1247, 1249 attached. As shown, the input and output ports include an internal metal nut 1244, 1246 that is designed to couple to the external barbs 1247, 1249. FIGS. 12D-12E illustrate the input and output ports and the internal metal nuts 1244, 1246 without barbs inserted and with caps covering the ports. In specific examples, the caps include USB caps which may be removed from the device to access the input and output ports.

The caps may be removed when making measurements with the flow meter. For example, the caps are removed and the flow meter may be used to obtain an airflow measurement. In other examples, one barb is inserted into one of the input and output ports and the flow meter is used to obtain a gauge pressure measurement using the one of the input and output ports and a coupled hose. In further examples, barbs are inserted into both of the input and output ports and the flow meter is used to obtain a differential measurement using both the input and output ports and coupled hoses.

As a specific example, a gauge pressure of an HVAC system may be obtained using one measurement input port connected to the HVAC system through the barb and hose while leaving the second output port having the cap open (and without a barb and/or hose connected). The device may be used to check the overall HVAC system performance through an example four-step measurement method. The four measurement may include use of one of the hoses coupled to one of ports of the device. For example, a hose may be coupled to the input port or the output port (which is coupled to the chamber and the flow meter) at different times and for obtaining the four measurements. The example four measurements of the HVAC system may be obtained before a filter, after the filter, before the coil and after the coil of the HVAC system, and which may be used to verify blower conditions are within specifications. In other examples, the differential measurement may be obtained using two gauge pressure measurements. The two measurements may include use of one of the hoses coupled to one of the ports of the device as described above. The first measurement may be obtained before the coil and the second measurement may be made after the filter. In other examples, a differential pressure measurement is obtained using one measurement. In such an example, the device is coupled to the HVAC via both the input port and the output port and two hoses. The measurement is obtained by coupling the hoses, which are coupled to the input and output ports of the device, after the filter and before the coil of the HVAC system, for example.

A number of the above illustrated devices may include additional features and/or tools. For example, the device having the rangefinder and the gyroscope and/or other of the above-described devices described herein may further include a magnet on the top side of the housing. The top side may be substantially flat such that a user may place metal components, such as nails and screws, on the top side and the magnet attracts the metal components. Other additional features and/or tools include various combinations of a camera, a proximity sensor, power buttons, input/outputs, lanyard connectors, among other additions.

In some specific examples, the various above described devices may further include a plurality of radio components used to communicate data to external circuitry. Example radio components include radio-frequency identification (RFID) and cellular low band. The device may include an antenna or a plurality of antennas. One antenna, for example, may be shared between two of the radio components. A switch may selectively couple the antenna to the two radio components, such as RFID ultra-high frequency low band and cellular low band/ long-term evolution (LTE). The switch may include a single pole double throw (SPDT) switch placed proximal to a triplexer such that the DIV medium band (MB) and high band (HB) may not be effected.

As shown herein, example devices in accordance with the present disclosure may include a multi-measurement device having a number of integrated tools. Example tools include the gas sensor as illustrated by FIGS. 1A-4, a combustion sensor as illustrated by FIGS. 6A-6B, non-contact voltage sensor as illustrated by FIGS. 7A-8, a rangefinder as illustrated by FIGS. 9A-9D, a stud finder and gyroscope as illustrated by FIG. 10A-10B, airflow measurement tool as illustrated by FIG. 5A, a ruler with a built-in protractor, a flow meter as illustrated by FIGS. 11A-11B and 12A-12E, a level using the gyroscope, a UV light, a flashlight, a proximity sensor, a vibration meter using the gyroscope, front facing and rear facing cameras, thermal imaging camera, a noise meter, and various other features such as a lanyard connector, graphical user interface, input/output connectors, and that the device is water resistant or water proof. Example devices are not limited to devices which include all of the above tools and features, and may include devices that include different combination of such tools and features.

In various examples, the above-described devices may be water resistant or water proof. For example, the device includes a plurality of channels and ports, with the ports providing air from the atmosphere to the channels internal to the housing. For example, a mesh may be located at an intersection of the ports and the channels to prevent or mitigate liquid from entering into the channels.

Based upon the above discussion and illustrations, various modifications and changes may be made to the various examples without strictly following those illustrated and described herein. For example, methods as shown in the Figures may involve actions carried out in various orders, with aspects herein retained, or may involve fewer or more actions. Various noted examples may be combined, such as by combining tools illustrated by FIGS. 1A-4, FIG. 6, FIGS. 7A-8, FIGS. 9A-9D, and FIGS. 10A-10B, such as shown by the device illustrated by FIGS. 5A-5D. In other examples, a device may include different subsets of the tools described herein, such as device having the tools illustrated by FIG. 6, FIGS. 7A-8, FIGS. 9A-9D, and FIG. 10A. Such modifications do not depart from the scope of various aspects of the disclosure, including aspects set forth in the claims.

What is claimed is:

1. A device comprising:
a housing including a channel to provide air to a chamber;
the chamber located within the housing and coupled to the channel;
an infrared light source to output an infrared beam through the chamber;
a gas sensor to measure radiation absorbed at different frequencies of the infrared beam; and
a processor coupled to the gas sensor to detect gas molecules present in the air within the chamber based on the measured radiation absorbed.

2. The device of claim 1, wherein the housing includes a front side, a back side, a top side, a bottom side, and two peripheral sides, a plurality of ports located on the top side and back side coupled to the channel that provides air to the chamber and an additional channel that provides the air from the chamber, and the device further including a mesh proximal to the plurality of ports to mitigate liquid from entering the channel and the additional channel.

3. The device of claim 1, wherein the housing further includes a plurality of ports and a plurality of channels, including the channel, to provide an air inlet and outlet pathways that direct air to the chamber and from the chamber, the device further including a fan proximal to the plurality of ports and the plurality of channels to draw the air into the chamber through the air inlet pathway.

4. The device of claim 1, wherein the gas sensor includes a methane sensor and a carbon-dioxide sensor and the infrared light source is to output the infrared beam through the chamber and toward the gas sensor.

5. The device of claim 1, further including a combustion chamber and a volatile organic compounds (VOC) sensor and a heat source to heat material in the combustion chamber and the processor is further to detect organic compounds present in response thereto.

6. The device of claim 1, further including a fan located proximal to the channel to draw the air into the chamber and a combustion chamber located proximal to the fan and the channel to provide air to the combustion chamber, and a volatile organic compounds (VOC) sensor and a heat source to heat material from the air in the combustion chamber and the processor is further to detect organic compounds present in response thereto.

7. The device of claim 1, further including a non-contact voltage sensor disposed in the housing, the non-contact voltage sensor including:
a movable arm including an antenna to measure a voltage, wherein the movable arm coupled to a stationary arm and the movable arm is to move from a first position to a second position with respect to the stationary arm;
the stationary arm having an inverter to convert the measured voltage to a digital signal; and
a push-activated switch to provide an electrical connection between the antenna and the inverter in response to the movable arm being in the second position, and the processor is coupled to the non-contact voltage sensor to process the digital signal and output an indication of a voltage present.

8. The device of claim 1, wherein the housing further includes:
a rangefinder, including a laser source, to output a laser beam pulse toward an object and receive the laser beam pulse as reflected from the object and returned to the rangefinder; and
a gyroscope to obtain an angle of tilt of the device; and
the processor is coupled to the rangefinder and the gyroscope to:
measure a time of flight of the laser beam pulse as returned to the rangefinder;
determine a travel distance of the laser beam pulse using the time of flight; and
determine a distance from the device to the object using the travel distance and the angle of tilt.

9. The device of claim 1, further including a capacitive sensor including a first capacitive plate and a second capacitive plate on a surface of the housing and a digital compass disposed in the housing to provide a directional signal, and the processor is to:
detect a stud based on changes in capacitance between the first and second capacitive plates; and determine a material of the stud based on the directional signal from the digital compass.

10. A device comprising:
a housing;
a non-contact voltage sensor disposed in the housing, the non-contact voltage sensor including:
a movable arm including an antenna to measure a voltage, wherein the movable arm is coupled to a stationary arm and the movable arm is to move from a first position to a second position with respect to the stationary arm;
the stationary arm having an inverter to convert the measured voltage to a digital signal; and
a push-activated switch to provide an electrical connection between the antenna and the inverter in response to the movable arm being in the second position; and
a processor coupled to the non-contact voltage sensor and disposed in the housing, the processor to process the digital signal and output an indication of the measured voltage.

11. The device of claim 10, wherein the non-contact voltage sensor includes a push-push mechanism to move the movable arm from the first position to the second position and from the second position to the first position.

12. The device of claim 10, wherein the housing includes a front side, a back side, a top side, a bottom side, and two peripheral sides, and the non-contact voltage sensor is located on the top side, the device further including:
a plurality of channels to provide an air inlet pathway and an air outlet pathway;
a chamber located within the housing and coupled to the plurality of channels, wherein the air inlet pathway directs air to the chamber and the air outlet pathway directs the air from the chamber;
an infrared light source to output an infrared beam through the chamber and toward a gas sensor;
the gas sensor to measure radiation absorbed at different frequencies of the infrared beam; and
the processor is coupled to the gas sensor to detect gas molecules present in the air in the chamber based on the measured radiation absorbed.

13. The device of claim 10, wherein the housing further includes:
a rangefinder, including a laser source, to output a laser beam pulse toward an object and receive the laser beam pulse as reflected from the object; and
a gyroscope to obtain an angle of tilt of the device; and
the processor is coupled to the rangefinder and the gyroscope to:
measure a time of flight of the laser beam pulse as returned to the rangefinder;
determine a travel distance of the laser beam pulse using the time of flight; and
determine a distance from the device to the object using the travel distance and the angle of tilt.

14. The device of claim 10, further including an antenna, two radio components, and a switch, the switch to selectively couple the antenna to one of the two radio components.

15. A device comprising:
a rangefinder, including a laser source, to output a laser beam pulse toward an object and measure the laser beam pulse as reflected from the object and returned to the rangefinder;
a gyroscope to obtain an angle of tilt of the device while the laser beam pulse is output;
memory to store executable instructions; and
a processor coupled to the memory, the rangefinder, and the gyroscope, wherein the processor, in response to execution of the instructions, is to:
measure a time of flight of the laser beam pulse as returned to the rangefinder;
determine a travel distance of the laser beam pulse using the time of flight; and
determine a distance from the device to the object using the travel distance and the angle of tilt.

16. The device of claim 15, wherein the processor is to determine the distance that includes a level distance between the rangefinder and the object without the angle of tilt of the device and to store the distance in the memory.

17. The device of claim 15, wherein the rangefinder, gyroscope, processor and memory are part of a multi-measurement device having a housing, the housing including magnets on a top side to attract metal components.

18. The device of claim 15, wherein the device includes a display, and the processor is further to provide a graphical user interface on the display that includes a visual level based on the angle of tilt.

19. The device of claim 15, wherein the rangefinder, gyroscope, processor and memory are part of a multi-measurement device and the multi-measurement device further includes a housing having:
a channel to provide air to a chamber;
the chamber coupled to the channel;
an infrared light source to output an infrared beam through the chamber and toward a gas sensor;
the gas sensor to measure radiation absorbed at different frequencies of the infrared beam; and
the processor is coupled to the gas sensor to detect gas molecules present in the air in the chamber based on the measured radiation absorbed.

20. The device of claim 15, wherein the rangefinder, gyroscope, processor and memory are part of a multi-measurement device and the multi-measurement device further includes a housing having a non-contact voltage sensor including:
a movable arm including an antenna to measure a voltage, wherein the movable arm is coupled to a stationary arm and the movable arm is to move from a first position to a second position with respect to the stationary arm;
the stationary arm having an inverter to convert the voltage to a digital signal; and
a push-activated switch to provide an electrical connection between the antenna and the inverter in response to the movable arm being in the second position, and the processor is coupled to the non-contact voltage sensor to process the digital signal and output an indication of the measured voltage.
